(19) United States
(12) Patent Application Publication
(10) Pub. No.: US 2026/0033440 A1
(43) Pub. Date: Feb. 5, 2026

(54) Goathead Roller

(71) Applicants: Renee L Walstad, Payette, ID (US); Shawn D. Walstad, Payette, ID (US)

(72) Inventors: Renee L Walstad, Payette, ID (US); Shawn D. Walstad, Payette, ID (US)

(21) Appl. No.: 18/792,509

(22) Filed: Aug. 1, 2024

(51) Int. Cl. A01G 20/43

(52) U.S. Cl. CPC A01G 20/43

(57) ABSTRACT

The Goathead Roller is a product to get rid of goat head seeds/pods on the ground from the puncture vine family of weeds. It is a 13-inch diameter roller, 24 inches wide, and a handle attached to the roller. The total weight is about 25 pounds. The drum is covered with a sewn sleeve made of neoprene fabric. There is an adjustable scraper bar to scrape the goatheads from the fabric and into a catch basin as the Goathead Roller is rolled forward. The scraper bar has wing nuts on the top of the bar to make it easier to adjust the distance of the scraper bar from the fabric. A catch basin is attached to the roller frame underneath the scraper bar. The catch basin is emptied by ‘dumping’ the catch basin upside down.

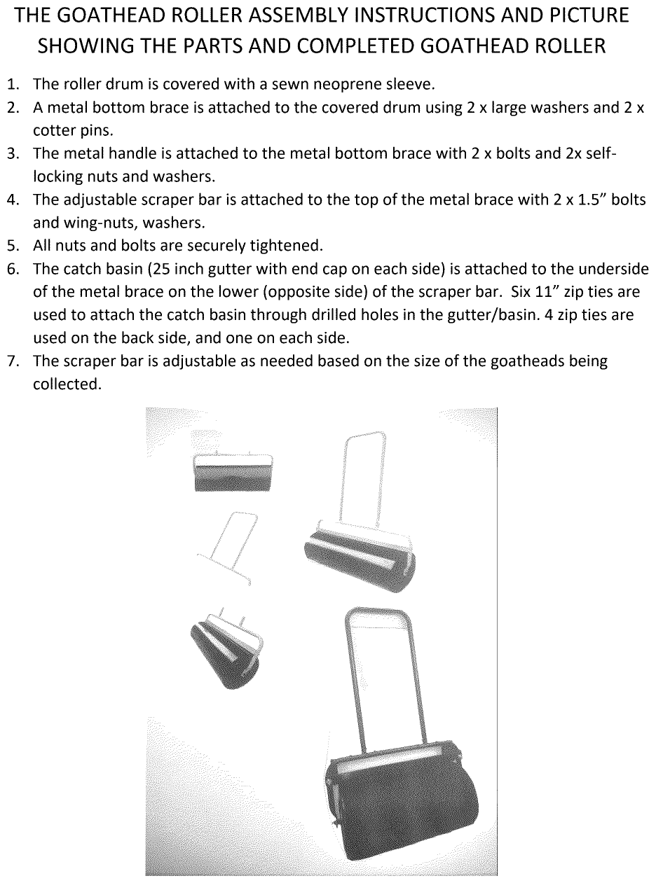

### CROSS-REFERENCE TO RELATED APPLICATIONS

The Goathead Roller is a weed control device. It is used to pick up seeds or seed pods from the ground hand free after weeds (primarily puncture vines) have dropped their seeds or seed pods either naturally, or after sprayed with herbicide.

### BACKGROUND OF THE INVENTION

The Goathead Roller was designed and built by developers/owners Shawn and Renee Walstad in late 2022 for use on their property. It was requested and sold to others later that year. In August of 2023 the owners applied for and were granted a non-provisional patent.

### SUMMARY OF THE INVENTION

The Goathead Roller is designed to pick up the ‘goat head’ seed pods from puncture vine plants and other poking seeds dropped from weeds. These seed pods are also known as sticker burs, sand burs, grass burs, devil thorns, cats-heads or tackweeds.

### BRIEF DESCRIPTION OF DRAWINGS

The drawing (below) shows the assembly parts of the Goathead Roller and the finished product with the neoprene sleeve on the drum, and the catch basin attached under the frame.

### DETAILED DESCRIPTION OF THE INVENTION

The Goathead Roller is a metal roller (usually sheet metal) that is attached to a frame so it can be pushed—similar to pushing a lawn mower. The weight of the Goathead Roller is about 25 pounds. The dimensions are generally a 13-inch diameter drum, with the drum width of 25 inches, and a handle attached to make it a roller. The total height with the drum and connected handle is about 4 feet. The handle comes in two pieces to make shipping easier.

The drum is covered with a sewn sleeve made of neoprene fabric.

There is a scraper bar that is adjustable, based on the size of the goat heads, to scrape the goatheads from the fabric and into a catch basin as the Goathead Roller is rolled forward. The scraper bar has a bolt on the bottom, and wing nuts on the top of the bar to make it easier to adjust the distance of the scraper bar from the fabric.

There is a catch basin attached to the roller frame underneath the scraper bar. The catch basin is made of a plastic gutter with two ends glued on the sides. The catch basin is emptied of goatheads by ‘dumping’ the catch basin upside down onto a tarp or cement surface.

### Goathead Roller Specifications for Assembly and Usage

### Goat-Head Roller—Patent Specifications

The Goathead Roller uses the Following Parts:
1 Drum (at least 25 inches wide, 13 inches diameter)
1 Handle attached to the metal brace
1 Metal Brace attached to the drum
1 Adjustable Scraper Bar
2 Cotter Pins & 2 Large Washers for sides of drum
4 Small Washers, 4 1.5″ Bolts, 2 Self-locking Nuts, 2 wingnuts
1 Gutter section 25 inches wide with 2 end caps
6 11″ Zip ties to hold the gutter to the frame right under the scraper bar
1 heavy duty neoprene sleeve sewed in a round cylinder shape
‘No slip tape’ is attached to the drum before the sleeve is pulled over to prevent slipping sideways

### Assembly:

Attach the metal brace with catch basin to the drum roller using the 2 large washers and the 2 cotter pins.
Attach the handle to the metal brace using 2 short bolts, 2 washers, and 2 self-locking nuts
The gutter catch basin is attached directly under the metal brace, and under the scraper bar using the provided 11″ zip ties.

Note, the scraper bar needs to be NOT touching the fabric sleeve. The scraper bar can be adjusted using the 1½ inch screws (top and bottom) and the distance set by using the mark on provided shim. The customer can loosen or tighten the scraper bar using the attached wing nuts on the top side.

The drums should not be filled with sand or water.

By design, it is important to remove goat-head plants before operating roller to prevent snagging of the fabric and the scraper bar. If the sleeve snags and tears in part, the customer can simply cut the torn part off and continue operating Goathead Roller.

Sleeves are designed to be replaceable and more sleeves are available to purchase and can be changed by removing cotter pins and washers, removing the used sleeve and replacing with a new sleeve.

1. The Goathead Roller is a metal rolling drum covered in fabric that is used to pick up seeds or seed pods on the ground from the puncture vine family of weeds.

2. The Goathead Roller has a sewn fabric covering the drum that is made of neoprene to temporarily ‘hold’ the goatheads until they are scraped off.

3. The Goathead Roller has a scraper bar that scrapes the goat head seeds off the neoprene fabric and into a catch basin that is attached under the frame.

4. The Goathead Roller has a catch basin that is emptied by simply dumping the whole frame over and emptying the goatheads onto a tarp for easy disposal.
